(19) United States
(12) Patent Application Publication
(10) Pub. No.: US 2005/0236968 A1
(43) Pub. Date: Oct. 27, 2005

(54) DISPLAY DEVICES AND METHODS FOR PRODUCING A DISPLAY DEVICE

(76) Inventors: Alec G Gunner, Cambridge (GB); Euan Smith, Cambridgeshire (GB)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/512,653

(22) PCT Filed: Apr. 23, 2003
(86) PCT No.: PCT/GB03/01720

§ 371 Date: May 5, 2005

(30) Foreign Application Priority Data
Apr. 25, 2002 (GB) 0209513.1

(51) Int. Cl. H05B 33/00

(52) U.S. Cl. 313/500

(57) ABSTRACT

Provided is a display device comprising: (a) a substrate; (b) a first electrode formed on the substrate; (c) a plurality of banks situated between pixel areas; (d) a light emissive layer formed on the pixel areas; and (e) a second electrode formed on the light emissive layer; wherein the banks are arranged in a zigzag pattern. Also provided is a method for producing a display device, which method comprises: (a) depositing a first electrode on a substrate, (b) depositing a plurality of banks on the substrate; (c) depositing a light emissive layer on a plurality of pixel areas; (d) depositing a second electrode on the light emissive layer, wherein the banks are deposited in a zigzag pattern.

This is the U.S. national phase of International Application No. PCT/GB03/01720 filed Apr. 23, 2003, the entire disclosure of which is incorporated herein by reference.

### BACKGROUND OF THE DISCLOSURE

1. Field of the Disclosure

This disclosure relates to display devices and more specifically to organic light emitting devices (OLEDs) which are advantageously employed in such displays. The disclosure is particularly concerned with displays and devices having improved strength and greater display area.

2. Related Technology

### SUMMARY

It is an aim of the disclosure to overcome the problems described above in relation to prior art methods and devices. It is a further aim of the present invention to provide a display device which is easier to manufacture, has a greater emissive area, can be driven at a lower brightness, has a longer lifetime and can be produced in a greater yield in the manufacturing process.

Accordingly, the disclosure provides a display device comprising:
(a) a substrate;
(b) a first electrode formed on the substrate;
(c) a plurality of banks situated between pixel areas;
(d) a light emissive layer formed on the pixel areas; and
(e) a second electrode formed on the light emissive layer,
wherein the banks are arranged in a zigzag pattern.

The disclosure also provides a method for providing a display device, and electronic or electroluminescent devices incorporating a display device.

### BRIEF DESCRIPTION OF THE DRAWINGS

The disclosure refers to the following drawing figures, in which:

FIG. 1a illustrates the cross-sectional structure of a typical organic light-emissive device;

FIG. 1b illustrates the cross section of an organic light emissive device comprising a further charge transport layer;

FIG. 2 depicts a unit cell (the equilateral triangle) for a hexagonal matrix of pixels having a side-length L and separated by banks of width y, and the formula for the % pixel area of the cell, 3(½Lx)/½z(2x+y)*100; and

FIG. 3 illustrates a further layer 7 beneath the banks 6 which further layer defines a well 8 in which the emissive layer is to be deposited—the further layer 7 encircles the pixel area and the front and rear portions defining the marked well are not shown for clarity.

FIG. 4 is a photograph of a substrate according to the disclosure showing a sinusoidal bank having a curve of radius 80 μm and a width of 20 μm.

FIG. 5 is a further photograph of a substrate according to the disclosure showing a sinusoidal bank having a curve of radius 80 μm and a width of 20 μm.

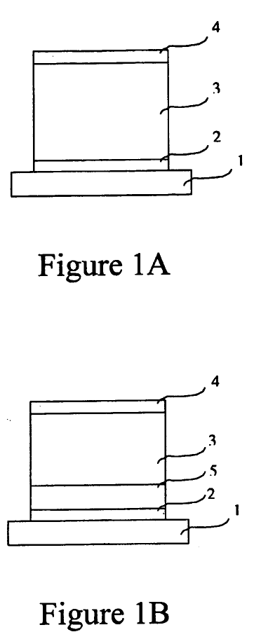

### DETAILED DESCRIPTION

In the context of the disclosure, the term zigzag pattern means a pattern in which the photoresist forming each bank is formed from portions alternating in orientation. For example, each portion may be linear, or substantially linear, joining to the next alternate portion at an apex, in the form of a classical zigzag: \hat{ }\hat{ }\hat{ }\hat{ }\hat{ }. In this form, each apex has an internal (smaller) and external (larger) angle defining the extent of the zigzag. The zigzag is preferably regular (in which all the portions are of the same length, or substantially the same length, and all the internal angles are the same, or substantially the same) but the present invention is not limited to regular zigzags. Thus, in an alternative embodiment, the ‘zig’ portions may be of different length to the ‘zag’ portions or to each other, and/or the internal angles may vary along the length of the bank. The angles may vary within the limits outlined below, provided that the adjacent banks do not come into contact with one another.

In the context of the disclosure, the pixel area means an area on which the emissive layer is deposited to form a display pixel. The pixel area may be defined by the banks themselves, or the devices may comprise a further layer which defines a well in which the emissive layer forming the pixel can be deposited (see below). The latter embodiment is especially preferred for full colour displays in which the red, green and blue pixels need to be separated from each other, and individually addressed.

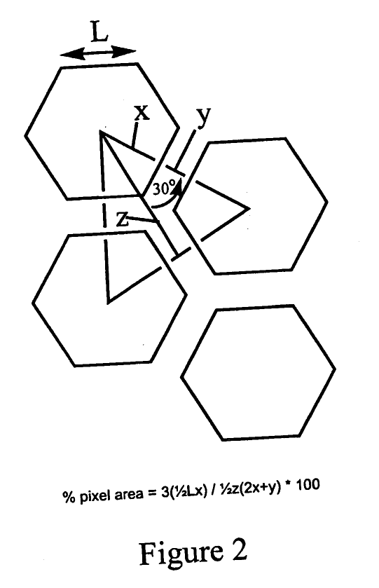

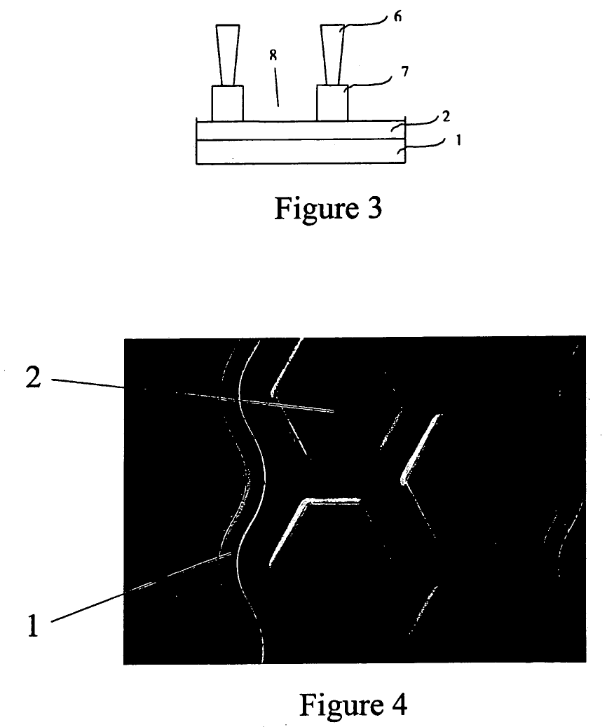

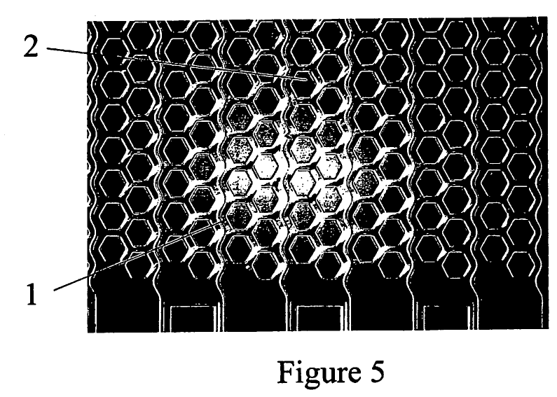

One problem with known methods employing banks, such as the methods described in EP-A-969 701, is that if the banks are too narrow they become weak and can easily break. Often the banks are narrower at the base than at the tip, since this shape provides a natural ‘shadow’ for ensuring that there is a break between one electrode strip and the next. This shape, while being advantageous for this reason, creates weak points at the base of the banks making them more likely to break. If the banks break too easily, then a significant proportion of the devices produced will not function, increasing the cost and decreasing the efficiency and yield of the whole manufacturing process. However, in order to provide the greatest possible emissive area, the banks should be made as narrow as possible. The wider the banks, the more area they occupy on the substrate, which in turn leaves less pixel area available for emissive material (see FIG. 2). If the emissive area is small, a device has to be driven at greater brightness to compensate, and this reduces the lifetime of the device. Thus, in the known methods a compromise needs to be reached to provide sufficient emissive area while ensuring that the banks have sufficient strength.

The great advantage of the zigzag banks employed in the disclosure is; that the zigzag structure allows much narrower banks to be formed without reducing their strength. Thus, in the present invention it is possible to employ banks having a width of around 2.0×10⁻⁵ m, whereas in known methods the banks typically have a width of 4.0×m. This can lead to gains in emissive area of more than 10%, which improves the quality of the devices and also helps to lengthen the lifetime of the devices, since they can be driven at lower brightness. Moreover, because the banks can be made stronger, the manufacturing process is more efficient and has a higher yield, since fewer defective devices are produced. Furthermore, the devices can tolerate more rigorous cleaning and handling techniques during manufacture, which can also lead to improvements in the overall quality of the devices produced. For example, one of the most problematic impurities that can be present in the devices is glass. Small particles of glass are often produced during manufacture, since the substrate is usually glass. These particles are very difficult to remove from the surface of devices without damaging them, since vigorous cleaning (e.g. high pressure spraying) is often the only way of removing the particles. However, the present zigzag banks can withstand these vigorous techniques.

The angle of the zigzag used is not particularly limited, provided that the zigzag is sufficient to strengthen the banks. It should be noted that it is preferred that each inner (or outer) angle (each ‘zig’ or ‘zag’ has one: smaller inner angle and one larger outer angle) is the same along the length of each bank, however, the present invention is not limited to this preferred embodiment (the angle may vary along the length of the bank). Thus, the preferred values of the angle referred to below are the average inner angles either along the length of the banks, or preferably across the whole display device. Thus the zigzag may have an average inner angle that is acute (less than 90°) or is a right angle (90°) or is an obtuse angle (more than 90° and less than 180°). In a preferred embodiment of the present invention the average inner zigzag angle is an obtuse angle. It is particularly preferred that the average inner zigzag angle is from 100°-150°. Most preferably the average inner angle is from 120°-140°.

Using the zigzag banks, it is possible to fabricate devices having a greater emissive area. A comparison of the emissive areas possible using the disclosure, as compared with prior art devices can be drawn with reference to FIG. 2 which depicts a unit cell (the equilateral triangle) for a hexagonal matrix of pixels. For a hexagonal pixel having a side length (L), the total area of the unit cell is ½z(2x+y). The area occupied by pixels is 3(½Lx). In the prior art devices the width of the banks (y) is generally around 4.0×10⁻⁵ m. The side length of a pixel is typically around 24.0×10⁻⁵ m. Thus, the percentage area occupied by pixels (emissive area) in known devices is around 83%. However, using the present banks, which may have a width as narrow as 1.0×10⁻⁵ m, the percentage emissive area for pixels having the same side length is more than 95%.

Substrates suitable for the organic electroluminescent devices of the disclosure include glass, ceramics and plastics such as acrylic resins, polycarbonate resins, polyester resins, polyethylene terephthalate resins and cyclic olefin resins. The substrate may be transparent, semi-transparent or, in cases where light is to be emitted from the opposite side of the device, opaque. The substrate may be rigid or flexible and may comprise a composite material such as, for example, the glass and plastic composite disclosed in EP 0,949,850.

In the devices of the disclosure it is preferred that the first electrode comprises a plurality of parallel strips (e.g. hexagonal zones connected by narrow strips) and the banks are oriented such that they are orthogonal to the strips of the first electrode. This in turn allows the second electrode to be deposited and separated by the banks into electrode strips, which are orthogonal to the first electrode. The first electrode may be transparent, in which case it is preferred that the substrate is also transparent. However, in an alternative arrangement, the second electrode may be transparent, in which case the substrate and first electrode do not need to be transparent. Thus, at least one of the electrodes is suitably light transmissive, and preferably transparent, suitably to light emitted from the light-emissive regions. Preferably the first electrode is the anode.

The disclosure further provides an electronic or electroluminescent device comprising a display element as defined above. In operating the devices, it is preferred that the first electrode is an anode and the second electrode is a cathode.

No doubt the teaching herein makes many other embodiments of, and effective alternatives to, the disclosure apparent to a person skilled in the art. The disclosure is not limited to the specific embodiments described herein but encompasses modifications which would be apparent to those skilled in the art and lying with the spirit and scope of the attached claims.

1. A display device comprising:
(a) a substrate;
(b) a first electrode formed on the substrate;
(c) a plurality of banks situated between pixel areas;
(d) a light emissive layer formed on the pixel areas; and
(e) a second electrode formed on the light emissive layer,
wherein the banks are arranged in a zigzag pattern.

2. A device according to claim 1, wherein the substrate is a transparent substrate.

3. A device according to claim 1 or claim 2, wherein the average inner zigzag angle Is an obtuse angle.

4. A device according to claim 3, wherein the average inner zigzag angle is from 100°-150°, more preferably the average inner zigzag angle is from 120°-140°.

5. A device according to claim 1 wherein the banks are curved.

6. A device according to claim 5 wherein the banks have a sinusoidal pattern with a radius of curvature of 20-180 μm, more preferably the banks have a sinusoidal pattern with a radius of curvature of 40-100 μm.

7. A device according to any preceding claim, wherein the banks comprise an upwardly protruding portion, which portion has a negative wall profile, which portion serves to separate the second electrode formed on one pixel area from the second electrode formed on an adjacent pixel area.

8. A device according to claim 7, wherein the width of the banks at the tip is 3.0×10⁻⁵ m or less, preferably wherein the width of the banks at the tip is 2.5×10⁻⁵ m or less, most preferably wherein the width of the banks at the tip is from 1.0×10⁻⁵ m to 2.5×10⁻⁵m.

9. A device according to any preceding claim, wherein the device comprises a further layer defining a well encircling the pixel areas.

10. A device according to claim 9, wherein the further layer defining the well is separate from the banks, and the banks are formed on the further layer.

11. A device according to any preceding claim, wherein the pixel areas comprise 85.0% or more of the total substrate area.

12. A device according to claim 11, wherein the pixel areas comprise 90% or more of the total substrate area.

13. A device according to claim 12, wherein the pixel areas comprise 95% or more of the total substrate area.

14. A device according to any preceding claim, wherein the pixel areas are hexagonal.

15. A device according to any preceding claim, which device comprises a further charge transport layer adjacent the emissive layer.

16. A device according to claim 15, wherein the charge transport layer is situated between the first electrode and the light emissive layer.

17. A device according to any preceding claim, wherein the first electrode comprises a plurality of parallel strips and the banks are oriented such that they are orthogonal to the strips of the first electrode.

18. A method for producing a display device, which method comprises:
(a) depositing a first electrode on a substrate;
(b) depositing a plurality of banks on the substrate;
(c) depositing a light emissive layer on a plurality of pixel areas;
(d) depositing a second electrode on the light emissive layer,
wherein the banks are deposited a zigzag pattern.

19. A method according to claim 18, wherein the average inner zigzag angle is an obtuse angle.

20. A method according to claim 19, wherein the average inner zigzag angle is from 100°-150°, more preferably the average inner zigzag angle is from 120°-140°.

21. A method according to claim 18 wherein the banks are curved.

22. A method according to claim 21 wherein the banks have a sinusoidal pattern with a radius of curvature of 20-180 μm, more preferably the banks have a sinusoidal pattern with a radius of curvature of 40-100 m.

23. A method according to any of claims 18-22, wherein the banks comprise an upwardly protruding portion, which portion has a negative wall profile, which portion serves to separate the second electrode formed on one pixel area from the second electrode formed on an adjacent pixel area.

24. A method according to any of claims 18-23, wherein a further layer is deposited defining a well encircling the pixel areas.

25. A method according to claim 24, wherein the further layer defining the well is separate from the banks and is deposited prior to forming the banks.

26. A method according to any of claims 18-25, wherein the photolithographic method employed for depositing the banks comprises negative photolithography.

27. A method according to any of claims 18-26, wherein the pixel areas are hexagonal.

28. A method according to any of claims 18-27, which method comprises a further step of depositing a charge transport layer adjacent the emissive layer.

29. A method according to claim 28, wherein the charge transport layer is deposited on the first electrode.

30. A method according to any of claims 18-29, wherein the first electrode forms a plurality of parallel strips and the banks are deposited such that they are they are orthogonal to the strips of the first electrode.

31. A method according to claim 30, wherein the first electrode is patterned by photolithography to form the pixel areas for accepting the light emissive layer.

32. An electronic or electroluminescent device comprising a display device as defined in any of claims 1-17.
